(19) United States
(12) Patent Application Publication
(10) Pub. No.: US 2007/0100836 A1
(43) Pub. Date: May 3, 2007

(54) User interface for providing third party content as an RSS feed

(75) Inventors: Matthias Eichstaedt, Sunnyvale, CA (US); Yunzhong Chen, San Jose, CA (US); Michael R. Cook, San Jose, CA (US); Ronald W. Ludwig, Tracy, CA (US); Sotirios Matzanas, San Francisco, CA (US); Kamlesh C. Pandey, Sunnyvale, CA (US); Adam Prishtina, San Jose, CA (US); Stephen W. Swales, Sunnyvale, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/262,501

(22) Filed: Oct. 28, 2005

(51) Int. Cl. G06F 17/30

(52) U.S. Cl. 707/10

(57) ABSTRACT

A system, method, and apparatus are directed to managing a subscription to an RSS feed. A search component enables searching over a network for content associated with an RSS feed. In one embodiment, the search component receives a search query in the form of a structured query language (SQL), Boolean expression, or the like. The search component may search for content based on the search query and validate the RSS feed associated with the results from the search. A list of validated RSS feeds may be sent to the user. The user may then select from the list and subscribe to a validated RSS feed. In addition, the user may employ the search query as an RSS feed. Thus, the same search may be performed automatically and the results compared to the previous search results. If a change in the search results is detected, the user may be alerted.

### FIELD OF THE INVENTION

The present invention relates generally to messaging over a network, and more particularly, but not exclusively, to a system and method for enabling a subscription to a Really Simple Syndication (RSS) feed, in part, by using a search query.

### BACKGROUND OF THE INVENTION

The amount of readily available content available to a user over a network, such as the Internet, has increased almost exponentially for the past several decades. Moreover, there is little indication that this rate of increase in available content will not continue in the foreseeable future. Providers of such content include blogs, news sources, sports sources, weather sources, libraries, friends, universities, businesses, and the like. Many of these content providers provide new or changed content almost regularly.

Because of the large amount of changing content, users often seek mechanisms that help them manage notifications of such changes. One such mechanism uses an RSS feed. Generally, RSS provides web content or summaries of web content together with links to the full versions of the content, and other meta-data. This information may be delivered as an XML file typically called an RSS feed, webfeed, RSS stream, or RSS channel. RSS feeds enable a user to subscribe to a content provider's website, or the like, and receive an alert indicating when a change to the content has occurred. However, locating content of interest that is also associated with an RSS feed remains a challenge. Thus, it is with respect to these considerations and others, that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows a functional block diagram illustrating one embodiment of a server device that may be included in a system implementing the invention;

FIG. 3 shows a functional block diagram illustrating one embodiment of a client device that may be included in a system implementing the invention;

FIG. 4 shows one embodiment of an example screen layout of a search result for use in subscribing to an RSS alert;

FIG. 5 shows one embodiment of an example screen layout for use in sharing an RSS alert;

FIG. 6 shows one embodiment of an example screen layout of use in managing a subscription to an RSS alert;

FIG. 7 illustrates a logical flow diagram generally showing an embodiment of a process for managing a subscription request based on a search query;

FIG. 8 illustrates a logical flow diagram generally showing one embodiment of a process for sharing a subscription to an RSS alert;

FIG. 9 illustrates a logical flow diagram generally showing one embodiment of a process for providing a subscription to an RSS alert over a network; and

FIG. 10 illustrates a logical flow diagram generally showing one embodiment of a process for providing an RSS alert based on a detected change to a search query result operating as an RSS feed, in accordance with the invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. The phrase “in another embodiment” as used herein does not necessarily refer to a different embodiment, although it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term RSS refers to any of a family of file formats and associated mechanisms usable to enable a user to subscribe to and receive network syndicated content from a content provider over a network. Typically, the file format that is employed is XML, however, the invention is not so limited, and other file formats may be used. Syndicated content includes, but is not limited to such content as news feeds, events listings, news stories, blog content, headlines, project updates, excerpts from discussion forums, or even corporate information. The abbreviation RSS as used herein includes at least the following: Rich Site Summary, RDF Site Summary, and Really Simple Syndication. Furthermore, although RSS is described, the invention is not limited to RSS. For example, Atom, a syndication specification adopted by the Internet Engineering Task Force (IETF) may also be employed. As used throughout this application, including the claims, RSS refers to RSS, Atom, and all syndication file formats derived therefrom. Moreover, as used herein, the terms “feed,” and “RSS feed,” sometimes called a channel, refers to any mechanism that enables content notification and/or content access from an RSS content source (RCS). In one embodiment, an RSS feed may represent a summary of content formatted in an RSS format and available for access.

Additionally, as used herein, the term “API” refers to any form of application programming interface, or the like. An API may be implemented in any programming language, or enabled by hardware. An API may expose objects along with their methods, function calls, or the like. Such an API may include, but is not limited to, a web services interface, a remote procedure call (RPC) interface, or the like. The web services interface may include Web Services Description Language (WSDL), Simple Object Access Protocol-EXtensible Markup Language (SOAP-XML), or the like.

Briefly stated, the present invention is directed towards a system, method, and apparatus for enabling a user to subscribe to an RSS feed, based, at least in part, on a search over a network. A search component enables the user to perform the search for content associated with an RSS feed that substantially matches a search query. In one embodiment, the user employs a structured query language (SQL) instruction. In another embodiment, the user may provide to the search component a Boolean expression that is useable to search for content associated with an RSS feed. In still another embodiment, the user may select a search query from a list of available search queries. In one embodiment, the results from the search are evaluated to verify that a valid RSS feed is available. In another embodiment, a list of validated RSS feeds is provided to the user. The user may then select from the list and subscribe to a validated RSS feed.

In another embodiment, the user may select to subscribe to the results of the search query as an RSS feed. Thus, the user may receive an RSS alert associated with when a change in the results of the search query is detected. The invention may automatically perform the search based on some criteria to determine whether the search results have changed. If the search results have changed for the same search query, an RSS alert may be provided to the user. In one embodiment, the criteria for automatically performing the search include performing the search periodically, based on some event, or the like. Thus, the user may subscribe to an RSS feed based on the results of a search query and further receive RSS alerts when the results of the search query change. In one embodiment, the results of the search query may include additional RSS feeds. In another embodiment, the results of the search query include content associated with one or more content source providers.

Thus, as more catalogs, libraries, or any other form of indexed or searchable content becomes available it can be processed in an automated way to provide notifications to a user on a wide variety of topics from a vast number of distinct data sources.

Illustrative Operating Environment

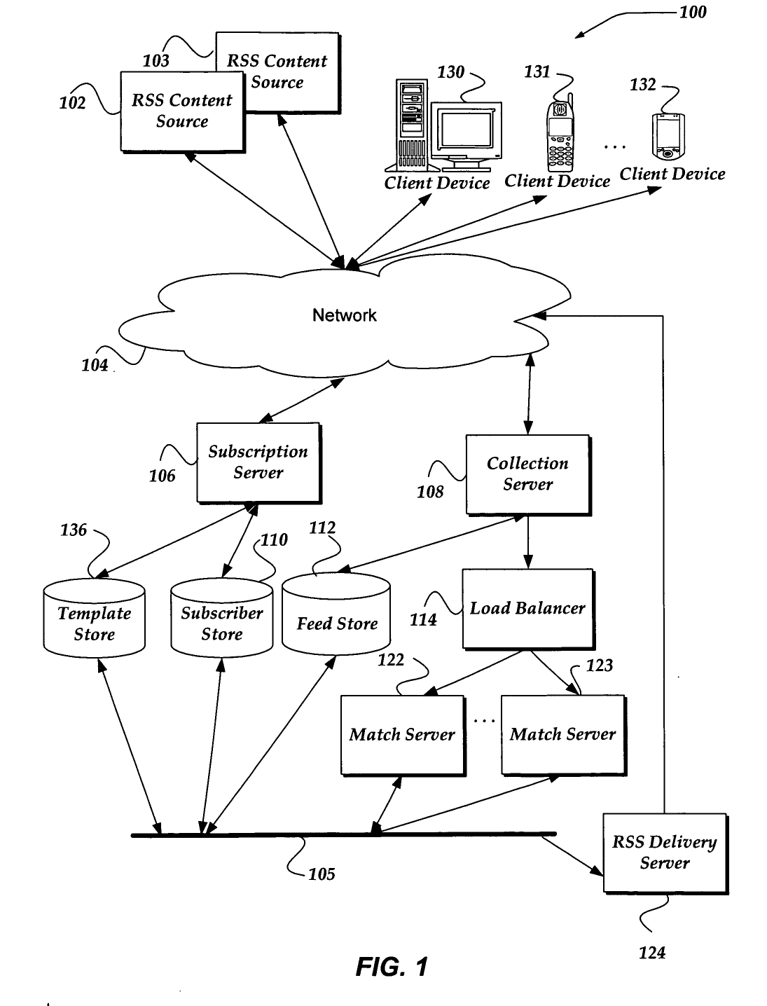

FIG. 1 shows components of an exemplary environment in which the invention may be practiced. Not all the components shown may be required to practice the invention, and variations in the arrangement and type of the components may be made without departing from the spirit or scope of the invention.

As shown in the figure, system 100 includes RCSs 102-103, client devices 130-132, networks 104-105, subscription server 106, collection server 108, load balancer 114, match servers 122-123, RSS delivery server 124, template store 136, subscriber store 110, and feed store 112.

Network 104 enables communication between RCSs 102-103, client devices 130-132, subscription server 106, and collection server 108. Subscription server 106 is also in communication with subscriber store 110 and template store 136. Collection server 108 is in communication also with feed store 112, and load balancer 114. Load balancer 114 is also in communication with match servers 122-123. Match servers 122-123 are in further communication with RSS delivery server 124, subscriber store 110, and feed store 112. RSS delivery server 124 is further in communication with template store 136.

Client devices 130-132 may include virtually any computing device that is configured to receive and to send information over a network, such as network 104. Such devices may include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Client devices 130-132 may also include other computing devices, such as personal computers, multiprocessor systems, microprocessor-based or programmable consumer electronics, network PCs, and the like. As such, client devices 130-132 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), Voice XML, and the like, to display and send a message.

Client devices 130-132 also may include at least one client application that is configured to receive content from another computing device. The client application may include a capability to provide and receive textual content, graphical content, audio content, alerts, messages, notifications, and the like. Moreover, client devices 130-132 may be further configured to communicate a message, such as through a Short Message Service (SMS), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 130-132 may also include a client application that is configured to enable a user of the device to subscribe to at least one RSS feed. Such subscription enables the user to receive through the client device an alert (or notification) that information is available for access. In another embodiment, the alert may include some or all of the information. Such information may include, but is not limited to, stock feeds, news articles, personal advertisements, shopping list prices, images, search results, blogs, sports, weather reports, other third party content providers, or the like. Moreover, the alerts may be provided to client devices 130-132 using any of a variety of delivery mechanisms, including IM, SMS, MMS, IRC, EMS, audio messages, HTML, email, or another messaging application.

In some cases, a user could subscribe to an alert for certain content to be provided by all mechanisms available on the client device, and another alert for other registered content to be provided by a single delivery mechanism. Additionally, some alerts may be provided through RSS delivery server 124 with a push mechanism to provide a relatively immediate alert. In this case, the invention might employ stored subscriber profile information to deliver the alert to the user using a variety of delivery mechanisms. In contrast, other alerts can be provided with a pull mechanism where RSS delivery server 124 provides an alert and/or content in response to a request from a user. The requests can also be scheduled at predefined times to provide alerts.

For client devices 130-132 that may reside behind a Network Address Translation (NAT) device (not shown) over network 104, the pull mechanism may employ a connection established by a pull request to send the alert to the user. In one embodiment, how often the pull alert might be provided may be determined by a frequency with which a user makes a pull request for the alert and/or content.

The client application residing on client devices 130-132 may also be configured to store a history of alerts. In one embodiment, the client application may be a messaging application such as described above.

In one embodiment, client devices 130-132 may enable a user to operate the computing device to make requests for data and/or services from other computers on the network. Often, the requested data resides in computing devices such as RSS delivery server 124, RCSs 102-103, or the like. Thus, in this specification, the term “client” refers to a computer's general role as a requester of data or services, and the term “server” refers to a computer's role as a provider of data or services. In general, it is possible that a computer can act as a client, requesting data or services in one transaction and act as a server, providing data or services in another transaction, thus changing its role from client to server or vice versa.

RCSs 102-103 represent virtually any network device that is configured to provide the content through an RSS feed mechanism. Source RCSs 102-103 may include businesses, blogs, universities, friends, news sources, or the like that may provide various content, including personal content, educational content, advertisements, business content, or any of a variety of other topical content. RCSs 102-103 may provide the content using either a push mechanism, and/or a pull mechanism. That is, in one embodiment, at least one RCS may provide content, an alert, or the like, to collection server 108 indicating that content is available for access. In another embodiment, at least one RCS may be pulled using a variety of mechanisms, including queries, or the like, by such as collection server 108, to determine availability of content.

Devices that may operate as RCSs 102-103 include personal computers, desktop computers, multiprocessor systems, microprocessor-based or programmable consumer electronics, network PCs, servers, or the like.

Networks 104-105 are configured to couple one computing device with another computing device. Networks 104-105 may be enabled to employ any form of computer readable media for communicating information from one electronic device to another. Also, networks 104-105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Furthermore, remote computers and other related electronic devices could be remotely connected to either LANs or WANs via a modem and temporary telephone link.

Networks 104-105 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 104-105 may also include an autonomous system of terminals, gateways, routers, and the like connected by wireless radio links, and the like. These connectors may be configured to move freely and randomly and organize themselves arbitrarily, such that the topology of networks 104-105 may change rapidly.

Networks 104-105 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, and future access networks may enable wide area coverage for mobile devices, such as one or more of client devices 130-132, with various degrees of mobility. For example, networks 104-105 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 104-105 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 104-105 may include virtually any wired and/or wireless communication mechanisms by which information may travel between one computing device and another computing device, network, and the like. In one embodiment, network 105 may represent a LAN that is configured behind a firewall (not shown), within a business data center, or the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Subscription server 106 may include virtually any network device that is configured to provide an interface for use with a client device, such as client devices 130-132 for managing an RSS alert. In one embodiment, the interface may be a user interface. The user interface may be configured to enable a user to subscribe to an RSS feed, unsubscribe to an RSS feed, modify options associated with an RSS feed, or the like. In one embodiment, several user interface menus are arranged for the user to subscribe to an RSS feed based, in part, on whether the user accesses the user interface from a network location that includes associated RSS feed information, whether the user accesses subscription server 106 from a network location when there is no RSS feed information available, but the user may have already subscribed to at least one RSS feed, or whether the user has no current subscriptions to RSS feeds through subscription server 106. In one embodiment, the user may be enabled to search for an RSS feed using a search query. The results of the search may provide an RSS feed to which the user may then subscribe. In one embodiment, the search query may be provided to collection server 108 for automatically performing the search query and providing an RSS alert to the user when a change in the results is detected.

Subscription server 106 may also request from client devices 130-132, various subscriber profile information, including, but not limited to a user identifier (user-id), user name, alert type, alert sub-type, frequency of receiving the alert, mechanism to receive the alert, RSS feed associated with an alert, or other information. Subscription server 106 may store such subscriber profile information in subscriber store 110.

In one embodiment, subscription server 106 may be configured to provide an API or the like, for use with a client device, such as client devices 130-132. The API may be configured to enable a client application running on a client device to subscribe to an RSS feed, unsubscribe to an RSS feed, modify options associated with an RSS feed, or the like.

Subscriber store 110 includes virtually any device that may be configured to receive and manage subscriber profile information, including, but not limited to a volatile and nonvolatile, removable and non-removable media implemented in any method or technology for storage of subscriber profile information, including computer readable instructions, data structures, program modules, or other data. Examples of computer storage media usable for subscriber store 110 include RAM, CD-ROM, DVD, optical storage, magnetic cassettes, magnetic tape, disk storage and/or any other magnetic storage devices, and/or any other medium that can store information that can be accessed by a computing device. Moreover, subscriber store 110 may be configured to employ a variety of mechanisms to manage subscriber profile information, including, documents, tables, files, scripts, applications, databases, spreadsheets, or the like.

In one embodiment, subscriber store 110 may store the subscriber's profile information, including email, telephone number, instant messenger identifier, and the like. The subscriber store 1 10 may also store the delivery options associated to the subscriber profile information and at least one RCS, and/or RCS content, or the like. The delivery options may include frequency of delivery, mode(s) of delivery, target language of delivery, transcoding options to transform the content from one format into another, cut-off time stamps to prevent delivery before a certain time, a list of other user-ids to which a particular alert may also be automatically routed, or the like. In one embodiment, subscriber store 110 may store the delivery options based, in part, on at least some portion of the subscriber's profile information.

Template store 136 includes virtually any device that may be configured to receive and manage customized templates. Template store 136 is substantially similar to subscriber store 110. In one embodiment, template store 136 may store customized templates based on the RCS, and/or a characteristic of the subscriber profile, or the like. The customized template may include additional information about the RCS, co-branding information associated with the RCS, a third party source, an advertisement selected by the RCS content and/or the RCS, an advertisement selected based on a client device type, or the like. In one embodiment, the customized templates may be in a form of a script, a web page with embedded scripting instructions, an extensible Stylesheet Language (XSL) transformation, or the like.

Collection server 108 includes virtually any network device that may be configured to determine an availability of RCS content for access by another computing device, such as client devices 130-132. Collection server 108 further provides information about the RCS content to feed store 112, and through load balancer 114 to match servers 122-123. Devices that may operate as collection server 108 include personal computers, desktop computers, multiprocessor systems, microprocessor-based or programmable consumer electronics, network PCs, servers, or the like.

Collection server 108 may include a ping service, query mechanism, or the like, that is configured to determine whether an RCS content is available. In one embodiment, collection server 108 may listen for updates from a variety of pre-determined RCSs, such as RCSs 102-103. In another embodiment, collection server 108 may receive a notification from RCSs 102-103, indicating that content is available for access. In one embodiment, the notification is sent to collection server 108 using a ping type of mechanism that includes an identifier of the RSS feed. In one embodiment, the RSS feed identifier is an RSS URL. Moreover, in one embodiment, the notification of RCS content may also include the content. It is further noted that an RCS may provide more than one RSS feed. Thus, an RCS, such as RCSs 102-103, may have associated with it more than one RSS feed identifier. For example, an RCS 102 may provide an RSS feed for news, another for a blog, for weather, another for sports, or still another RSS feed for traffic.

Collection server 108 may also employ a crawler, such as a web crawler, RSS crawler, or the like, that is configured to search for RCS content over network 104. Collection server 108 may perform the crawls based on at least one pre-determined network address for an RCS content source. However, collection server 108 is not so limited. For example, collection server 108 may receive a search query for a type of content, such as from a subscriber, or the like, and perform the search query for the type of content over network 104. For example, in one embodiment, a subscriber may provide a Boolean query comprising of one or more logical operators, such as AND, OR, NOT, or the like, along with one or more search terms. Collection server 108 may provide the search query to a crawler for use in performing search for an RCS site, or the like, that may provide results that are similar to the search query. In any event, the results of crawling network 104 may be to identify RCS content sources that have content. When such an RCS content source is located, collection server 108 may access the content.

Collection server 108 may also enable a user to receive an RSS alert when a change is detected in a result of the search query. Thus, collection server 108 may store the search query received from the subscriber. In one embodiment, the search query is stored in subscriber store 110, and associated with the subscriber. In one embodiment, the search query results operate as a separate RSS feed.

Collection server 108 may then periodically automatically perform the search query on behalf of the subscriber. Collection server 108 may receive the results of the search query and compare the results to results obtained from substantially the same search query at a previous time. If collection server 108 detects that the results between the searches is substantially different, collection server 108 may provide information to match servers 122-123 through load-balancer 114, or the like, to enable the subscriber to receive an RSS alert regarding the detected changes. In one embodiment, the subscriber may then elect to modify a subscription based, at least in part, on the detected changes. It is noted, however, that collection server 108 is not constrained to automatically performing the search and comparisons periodically, but may also perform them a periodically, based on an event, or the like. Thus, in one embodiment, the search query results are employable as an RSS feed for which the subscriber may have subscribed to.

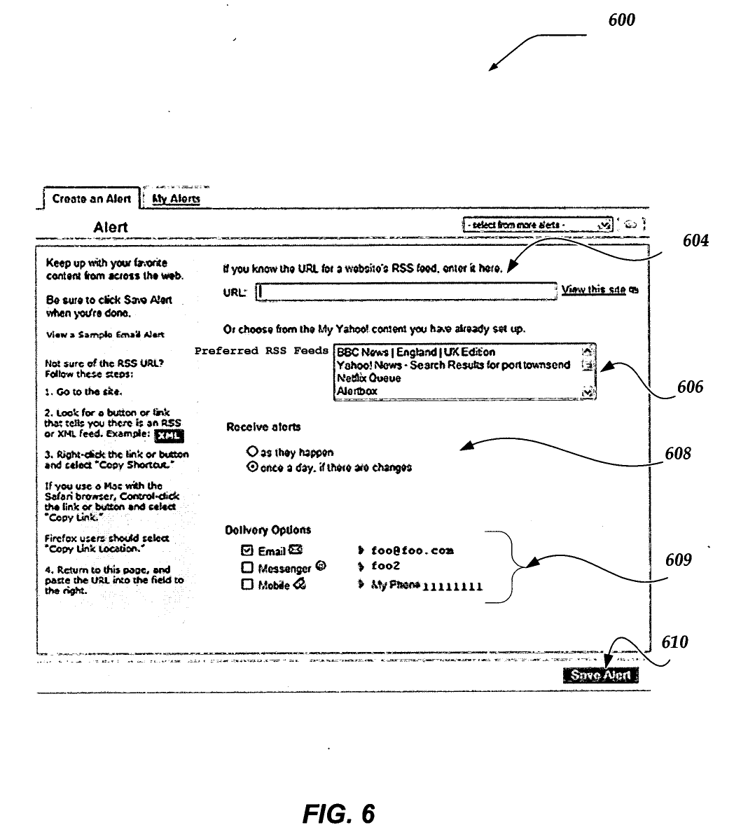

Moreover, collection server 108 may also provide to subscription server 106, or the like, the stored search query so that it may be made available to another subscriber. For example, in one embodiment, the search query may be selected by the other subscriber, and performed for the other subscriber. In one embodiment, the other subscriber may select the search query from a plurality of stored search queries through an interface such as described below in conjunction with FIG. 6.

In one embodiment, the search query may also be made available to another subscriber, through, for example, a recommended list of possible RSS feeds to which the other subscriber may subscribe.

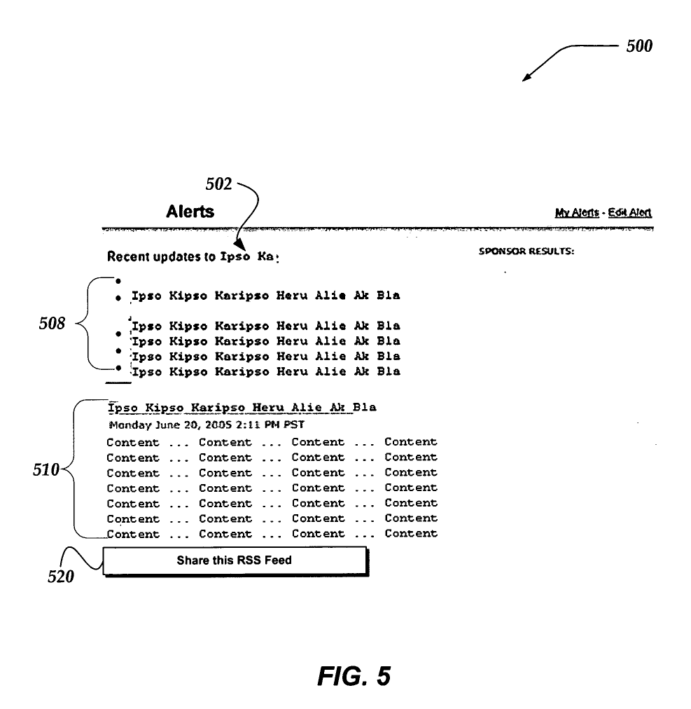

Collection server 108 may further search feed store 112 to determine whether the received content has already been received for an RCS. Content may be received by collection server 108 for any of a variety of reasons, including because an RCS may provide numerous notifications over a period of time for a same content. Thus, if collection server 108 determines that the RCS content has already been received, collection server 108 may select to drop the most recent content (e.g., duplicated content). If collection server 108 determines that the received notification is for a content that has not been received, collection server 108 may provide the content to feed store 112 for storage. In addition, collection server 108 may also provide a notification of the content to load-balancer 114. In one embodiment, the notification to load-balancer 114 includes an identifier for the RSS feed having the content. In one embodiment, collection server 108 may generate an XML document which includes the RSS feed identifier. Moreover, in one embodiment, collection server 108 may employ a process substantially similar to process 500 described below in conjunction with FIG. 5 to perform at least some of its actions.

Feed store 112 includes virtually any computer storage media that may be configured to receive and manage RCS content. Examples of computer storage media usable for subscriber store 110 include RAM, CD-ROM, DVD, optical storage, magnetic cassettes, magnetic tape, disk storage and/or any other magnetic storage devices, and/or any other medium that can store information that can be accessed by a computing device. Moreover, feed store 112 may be configured to employ a variety of mechanisms to manage RCS content, including, documents, tables, files, scripts, applications, databases, spreadsheets, or the like. In one embodiment, feed store 112 may store the RCS content based, in part, on an RSS feed identifier. The RCS content may also include additional information associated with the RCS content, including, but not limited to a time stamp indicating when the RCS content was received.

Load-balancer 114 may include virtually any device that manages network traffic. Such devices include, for example, routers, proxies, firewalls, load balancers, cache devices, devices that perform network address translation, any combination of the preceding devices, and the like. Load-balancer 114 may be implemented using one or more personal computers, servers, multiprocessor systems, microprocessor-based or programmable consumer electronics, network PCs, RF devices, IR devices, integrated devices combining one or more of the preceding devices, and the like. Such devices may be implemented solely in hardware or in hardware and software. In one embodiment, load-balancer 114 may be implemented as at least one application residing within collection server 108. Moreover, although multiple load-balancers are not illustrated, the invention is not constrained to use of a single load-balancer. For example, multiple load-balancers may be implemented across distinct servers, multiple load-balancers may be implemented as multiple processes within a single server, or the like, without departing from the scope or spirit of the invention. Load-balancer 114 may be configured to control a flow of data delivered to an array of servers, such as match servers 122-123. In one embodiment, load-balancer 114 receives an XML document that may include an RSS URL associated with an RCS, such as RCSs 102-103. Load-balancer 114 may direct the document to a particular match server based on network traffic, network topology, capacity of a server, content requested, an authentication, or authorization status, and a host of other traffic distribution mechanisms. For example, in one embodiment, load-balancer 114 may distribute the XML documents across match servers 122-123 using a round-robin mechanism. However, other load-balancing mechanisms may also be employed, without departing from the scope or spirit of the invention. For example, load-balancer 114 may also control a flow of data based on an RSS feed identifier, RCS content type, a subscriber, a delivery type, or the like. In one embodiment, load-balancer 114 may be configured to deliver RSS feed identifiers based on a particular RCS content type, a subscriber, a delivery type, or the like.

One embodiment of a match server is described in more detail below in conjunction with FIG. 1. Briefly, however, match servers 122-123 include virtually any network device that may be configured to receive an indication of RCS content, and to create matches based, in part, on subscriber profile information, for the RCS content and to send the matches to RSS delivery server 124 for distribution to the matched subscribers.

Match servers 122-123 may further employ a state store (not shown) to determine, at least in part, whether a received RCS content has been sent to the matched subscribers. If the RCS content has already been sent, then match servers 122-123 may select to not send the matches to RSS delivery server 124. RCS content may have already been sent to the matched subscribers, for example, because one of the other match servers already sent the content.

Devices that may operate as match servers 122-123 include personal computers, desktop computers, multiprocessor systems, microprocessor-based or programmable consumer electronics, network PCs, servers, or the like. Moreover, although multiple match server devices are illustrated, the invention is not constrained to multiple devices. For example, multiple match servers may be implemented as multiple processes within a single server device, without departing from the scope or spirit of the invention.

RSS delivery server 124 includes virtually any network device that is configured to prioritize and manage distribution of alerts to a client device, such as client devices 130-132. RSS delivery server 124 may receive information from match servers 122-123 indicating that pushed content, pulled content, or the like is available. RSS delivery server 124 may further receive from match servers 122-123 a user identifier indicating which subscriber to provide the alert. RSS delivery server 124 may receive alert content from feed store 112, and additional subscriber profile information from subscriber store 110 to determine when and how to deliver the alert to a subscriber.

As alerts are prepared and delivered, a monitor mechanism (not shown) may monitor the flow of alerts for patterns and/or other insights. For example, the monitor mechanism may track and/or access information about a subscriber's behavior, such as navigating to Web sites, making online purchases, and the like. The tracked behavior also may indicate a subscriber's interests which may also be stored in the subscriber's profile in subscriber store 110. When an alert is to be delivered, it may be routed to one or more appropriate servers (not shown) for delivery by the subscriber's preferred mode(s) of delivery. For example, email alerts can be delivered via bulk servers. Alerts to wireless mobile devices can be delivered via a wireless server. Instant message alerts can be delivered via an instant message server, and so forth. Each alert may be generally communicated over network 104 to a client device identified in the subscriber's profile. Thus, the subscriber can indicate that the alert be delivered to one ore more of a client devices.

In one embodiment, RSS delivery server 124 may also receive various customized templates that may be combined with the RSS alerts, RCS content, or the like. In one embodiment, RSS delivery server 124 may receive the customized templates from RCSs 102-103. In another embodiment, RSS delivery server 124 may receive the customized templates from a client device, such as one of the client devices 130-132. RSS delivery server 124 may employ a customized template based on the RCS, and/or a characteristic of a subscriber, or the like. For example, the customized template may be selected to provide additional information about the RCS. Thus, the customized template may include co-branding information associated with the RCS, a third party source, an advertisement selected by the RCS content and/or the RCS, an advertisement selected based on a client device type, or the like. In one embodiment, the customized templates may be in a form of a script, a web page with embedded scripting instructions, an eXtensible Stylesheet Language (XSL) transformation, or the like. In another embodiment, a subscriber's behavior, including what type of RCS content the subscriber has requested, or the like, may be employed to customize the RSS alert, the RCS content, or the like. In yet another embodiment, the templates may modify the RCS content, such modification including appending, deleting, correcting the content, or the like. The modifications may be also based on the RCS content and/or the RCS, an advertisement selected based on a client device type, or the like.

In one embodiment, RSS delivery server 124 may retrieve delivery options associated with a particular subscriber and a particular RCS. Generally, the delivery options may be retrieved or received from any data source, such as subscriber store 110, or another device such as RCSs 102-103, or client devices 130-132, or the like. The RSS delivery server 124 may queue, or drop the delivery of the RSS alert, or modify the RCS content based in part on the delivery options.

The delivery options may include frequency of delivery, mode(s) of delivery, target language of delivery, transcoding options to transform the content from one format into another, cut-off time stamps to prevent delivery before a certain time, a list of other user-ids to which a particular alert may also be automatically routed, or the like. In one embodiment, the RSS delivery server 124 may queue the RSS alert for a particular subscriber and deliver newly arrived and queued RSS alert and/or RCS content at pre-defined intervals. In one embodiment, the RSS delivery server 124 may signal the monitor mechanism to route the message as described above based on the mode(s) of delivery. In one embodiment, the RCS content may be associated to a MIME type. In one embodiment, the RSS delivery server 124 may decode and/or encode the RCS content based on transcoding options. These transcoding options may include transcoding from one encoding of a particular type of media to another encoding. Transcoding options may also include converting from one media content type to another. Types of media content may include text, audio, video, images, or the like. Encodings may include unicode, UTF-7, UTF-8, CESU-8, UTF-16, or the like for text; JPEG, GIF, PNG, BMP, or the like for images; MP3, Real Audio format, or the like for audio; and MPEG, QuickTime Format, Windows Media Format, or the like for video.

In one embodiment, the delivery option may direct the RSS delivery server 124 to convert some or all of the RCS content into a speech synthesis/speech recognition format such as SSML, SABLE, JSML, Voice XML or the like, or to transcribe text into spoken language in an audio format through a speech synthesis/speech recognition mechanism, or from an audio format into transcribed text, or the like. In one embodiment, the delivery option may direct the RSS delivery server 124 to prepend, append, inline add, or replace media content into the RCS content, or the like. Such modifications may include adding media content, such as audio, video or images corresponding to weather changes, stock quote changes, or the like.

Although not illustrated, a mirror interface may be used to communicate with one or more mirrored components of system 100, including, but not limited to match servers 122-123, feed store 112, subscriber store 110, and/or template store 136. Thus, any, or all of system 100 may be reproduced for parallel processing, and/or failover processing. Such mirror interface may comprise one or more communication interfaces and/or associated network devices.

Illustrative Network Device

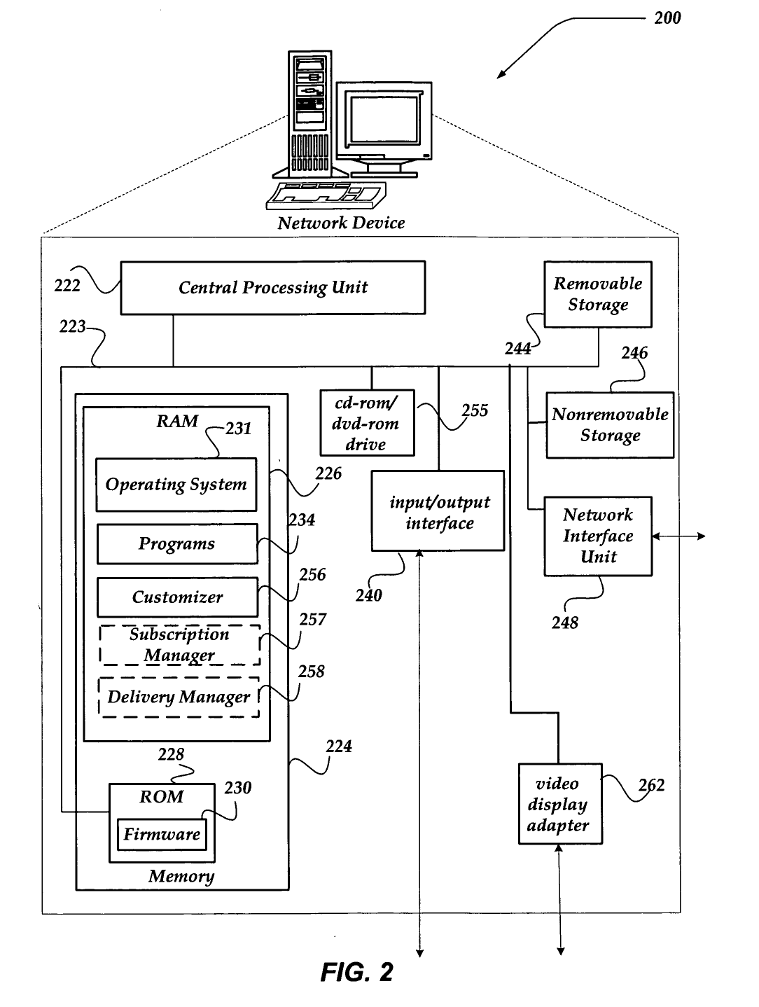

FIG. 2 shows an exemplary network device 200 that may operate as subscription server 106 and/or RSS delivery server 124 of FIG. 1. As illustrated below, network device 200 may also be arranged to operate to perform actions associated with both subscription server 106 and RSS delivery server 124 of FIG. 1. It will be appreciated that not all components of network device 200 are illustrated, and that network device 200 may include more or less components than those shown in FIG. 2.

As shown in FIG. 2, network device 200 includes at least one central processing unit 222 in communication with main memory 224 by way of bus 223 or the like. Main memory 224 generally includes RAM 226, ROM 228, and may include other storage means, such as one or more levels of cache (not shown). Main memory 224 illustrates a type of processor-readable media, namely computer storage media. Network device 200 includes cd-rom/dvd-rom drive 255, a form of CD-ROM, DVD, or other optical storage media. Computer storage media may also include volatile and nonvolatile, removable and non-removable media implemented in any method or technology for storage of information, such as processor-executable instructions, data structures, program modules, and the like. Other examples of computer storage media include EPROM, flash memory or other semiconductor memory technology, magnetic tape, magnetic disk storage or other magnetic storage devices, or any other medium that can be used to store the desired information and that can be accessed by a computing device.

Network device 200 includes an input/output interface 240 for communicating with input/output devices, such as a keyboard, mouse, printer, and the like. A user, such as a system administrator, or the like, of network device 200 may use input/output devices to interact by way of a user interface that may be separate from or integrated with operating system 231 and/or programs 234. Interaction with the user interface may include interaction by way of a visual display, using video display adapter 262.

Network device 200 may include secondary storage for storage of program modules, data, and the like not in main memory 224, including removable computer-readable storage 244 and/or non-removable computer-readable storage 246. Removable storage 244 may comprise one or more of optical disc media, floppy disks, and magnetic tape readable by way of an optical disc drive, floppy disk drive, and tape drive, respectively. Secondary storage may also include flash memory or other memory technology and generally includes any medium usable for storage of information and accessible by a computing device.

By way of network interface unit 248, network device 200 may communicate with a WAN, such as the Internet, a LAN, a wired telephone network, a wireless communications network, or some other communications network, such as network 105 of FIG. 1. Network interface unit 244 may comprise a transceiver, a network interface card, and the like. Network interface unit 244 is sometimes known as a transceiver, transceiving device, or network interface card (NIC).

Main memory 224 typically stores firmware 230 for boot-loading and controlling low-level operation of network device 200. Main memory 224 also stores programs for loading and execution by central processing unit 222, such as operating system 231 and other programs 234, which may include, for example, server applications, client applications, networking applications, messaging applications such as applications for RSS communication, and the like. Main memory 224 may further include customizer 256, delivery manager 258, and subscription manager 257.

Customizer 256 is configured to customize an RSS alert and/or RCS content, and a subscription to an RSS alert. In one embodiment, customizer 256 may be configured to receive an RSS alert and/or RCS content from delivery manager 258, along with at least one associated user-id. Customizer 256 may customize an RSS alert and/or RCS content and provide the information to delivery manager 258. For example, in one embodiment, customizer 256 may include a ‘share’ button, icon, link, or the like, within an RSS alert that enables a recipient of the RSS alert to indicate that the RSS alert is to be shared or sent to another user. One embodiment of such a share button is illustrated in FIG. 5.

Customization may also be based on the associated RCS content and/or subscriber profile information associated to the at least one user-id. Customizer 256 may receive the subscriber profile information from any data source, including subscriber store 110, RCSs 102-103, or client devices 130-132 of FIG. 1, or the like.

Customizer 256 may be further configured to receive RSS subscription information from subscription manager 257, along with an associated user-id, and possibly an RSS feed identifier. Customizer 256 may customize an RSS subscription and provide the customized RSS subscription to subscription manager 257. In one embodiment, the customization is based on the RSS feed identifier, and/or subscriber profile information associated to the user-id. For example, customization may be based on whether a subscriber profile indicates that the subscriber has subscribed to prior RSS alerts, has indicated a preferred type of content based in part on a behavior, is not currently subscribed to an RSS alert, or the like. Customizer 256 may receive the subscriber profile information from any data source, including subscriber store 110, RCSs 102-103, client devices 130-132 of FIG. 1, or the like.

Delivery manager 258 is configured to provide delivery of an RSS alert and/or RSS feed content to a subscriber. As shown, delivery manager 258 and subscription manager 257 may be implemented on the same device or on different devices. In one embodiment, delivery manager 258 prioritizes and manages distribution of alerts to a client device substantially similar to RSS delivery server 124 of FIG. 1. Substantially similar to RSS delivery server 124, delivery manager 258 may provide the RSS alert and/or RSS feed content to the subscriber using a variety of mechanisms, including, but not limited to, email, SMS, voice, IM, web browser, or the like. Delivery manager 258 may provide information to customizer 256 which customizer 256 may employ to customize an RSS alert, content, or the like. Delivery manager 258 may receive the customized RSS alert and/or RCS content from customizer 256.

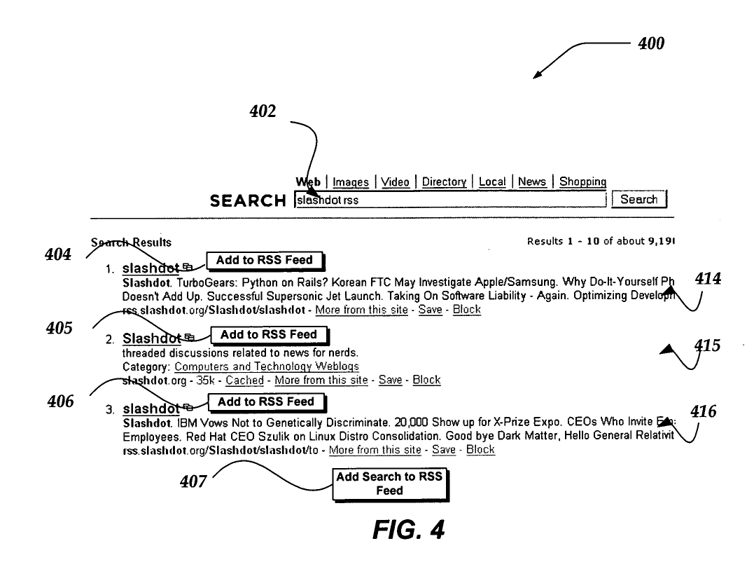

Subscription manager 257 is configured to provide an interface to another network device, such as client devices 130-132 of FIG. 1, to enable managing subscriptions to an RSS feed. In one embodiment, subscription manager 257 may receive subscription information from client devices 130-132, authenticate the received information, create a subscription to an RSS feed based on the received information, and send the subscription to a data store, such as subscriber store 110 of FIG. 1. Subscription manager 257 may also enable a user of the other network device to share the RSS feed with another user of another client device. Subscription manager 257 may also enable a user of the other network device to enter a search query useable to locate an RSS feed. In another embodiment the search query results may be used to operate as an RSS feed. The search query may include any of a variety of search mechanisms, including an SQL query, a Boolean statement, or the like. In one embodiment, the search query may be provided to subscription manager 257. In another embodiment, a third party, such as RCSs 102-103 of FIG. 1, or the like, may provide a search tool that may be used to search for an RSS feed based on the search query. The results of the search query may then be provided to subscription manager 257 for use in enabling the user to subscribe to an RSS feed, or the entire search query results as an RSS feed One embodiment of an interface for use in performing and/or displaying a result of a search for an RSS feed is described below in conjunction with FIG. 4.

In one embodiment, subscription manager 257, optionally in conjunction with customizer 256, provide to the other network device a subscription interface such as described below in conjunction with FIG. 6. In one embodiment, match servers 122-123 as shown in FIG. 1 may use the stored information for processing incoming RSS alerts.

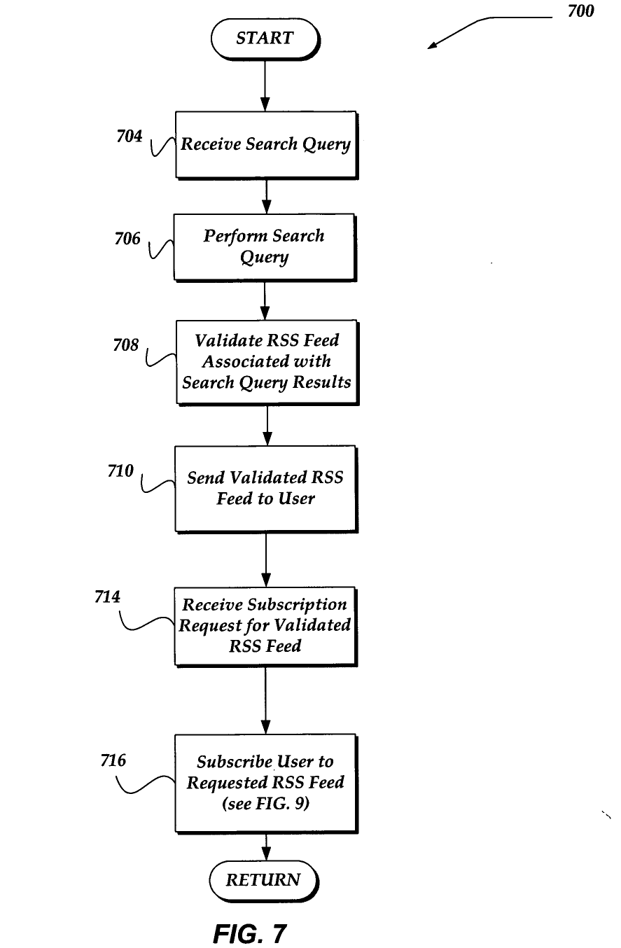

In one embodiment, delivery manager 258, subscription manager 257 and customizer 256 may employ processes substantially similar to those described below in conjunction with FIGS. 7-9 to perform at least some of the above actions.

Illustrative Client Device

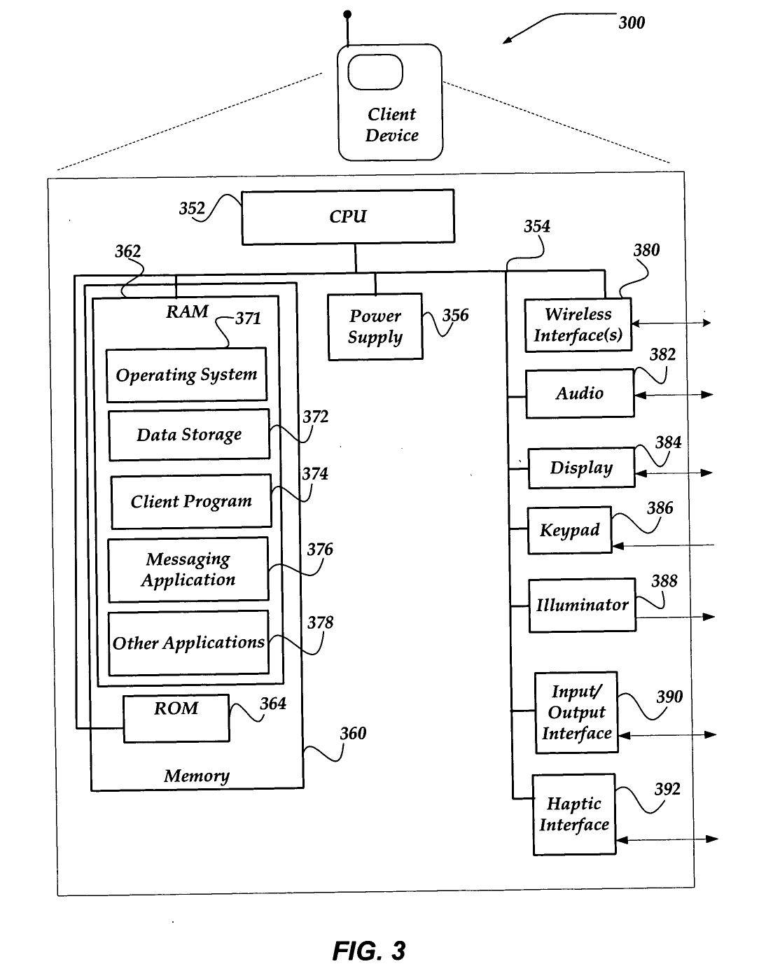

FIG. 3 shows one embodiment of a client device that may operate as a client device, such as client devices 130-132 of FIG. 1. In one embodiment, client device 300 is a mobile phone that is arranged to send and receive voice communications, text-based messages, multimedia data, and other data by way of one or more wireless communication interfaces. Generally, client device 300 may include any electronic device capable of such wireless communication, including, but not limited to, any personal electronic device. Client devices are typically capable of communication by connecting to one or more wireless networks, connecting to multiple nodes of a single wireless network, communicating over one or more channels to one or more networks, or otherwise engaging in one or more communication sessions. Such devices include mobile phones, cellular phones, smart phones, pagers, RF devices, IR devices, integrated devices combining one or more of the preceding devices, and the like. Client device 300 may also include other electronic devices such as personal digital assistants, handheld computers, personal computers, microprocessor-based or programmable consumer electronic devices, wearable computers, and the like.

Client device 300 may include many more components than those shown in FIG. 3, and need not include all of the components shown therein. However, the components shown are sufficient to disclose an illustrative embodiment for practicing the present invention. As shown in the figure, client device 300 includes CPU 352 in communication with memory 360 by way of bus 354.

Client device 300 also includes power supply 356, one or more wireless interfaces 380, audio interface 382, display 384, keypad 386, illuminator 388, input/output interface 390, and haptic interface 392. Power supply 356 provides power to client device 300. A rechargeable or non-rechargeable battery may be used to provide power. The power may also be provided by an external power source, such as an AC adapter or a powered docking cradle that supplements and/or recharges a battery.

Client device 300 may optionally communicate with a base station (not shown), or directly with another wireless mobile or non-mobile device. Input/output interface 390 includes circuitry for coupling client device 300 to one or more wireless networks, and is constructed for use with one or more communication protocols and technologies including, but not limited to, GSM, CDMA, TDMA, EDGE, UMTS, WCDMA, CDMA 2000, UDP, TCP/IP, SMS, GPRS, WAP, UWB, WiMax, IEEE 802.11x, and the like. Audio interface 382 is arranged to produce and receive audio signals, such as the sound of a human voice. For example, audio interface 382 may be coupled to a speaker and microphone (not shown) to enable telecommunication with others and/or to generate an audio acknowledgement for some action. Display 384 may be a liquid crystal display, gas plasma, light emitting diode, or any other type of display used with a client device or other wireless device. Display 384 may also include a touch sensitive screen arranged to receive input from an object such as a stylus or a human digit.

Keypad 386 may include any input device arranged to receive input from a user. For example, keypad 386 may include a push button numeric dial or an alphanumeric keyboard. Keypad 386 may also include command buttons that are associated with selecting and sending images. Illuminator 388 may provide a status indication and/or provide light. Illuminator 388 may remain active for specific periods of time or in response to events. For example, if illuminator 388 is active, it may backlight the buttons on keypad 386 and remain active while client device 300 is powered. Also, illuminator 388 may backlight these buttons in various patterns if particular actions are performed, such as dialing another client device. Illuminator 388 may also cause light sources positioned within a transparent or translucent case of client device 300 to illuminate in response to actions.

Client device 300 also includes input/output interface 390 for communicating with external devices. Input/output interface 390 may employ one or more appropriate communication technologies, such as USB, IR, Bluetooth, and the like. Haptic interface 392 is arranged to provide tactile feedback to a user of client device 300. For example, haptic interface 392 may be employed to vibrate client device 300 in a particular way when a user of another device, such as a mobile phone, is calling client device 300.

Memory 360 may include RAM 362, ROM 364, and other storage means. Memory 360 also provides data storage 372 and storage of programs, including, for example, operating system 371, client program 374, messaging application 376, and other applications 378. Such programs may include processor-executable instructions which, when executed on client device 300, cause transmission, reception, and other processing of audio data, video data, text messaging data, web pages, Wireless Markup Language (WML) pages, and the like, and enable wireless communication with another device.

Messaging application 376 is configured to receive RSS feeds, including an RSS alert, and RCS content. Messaging application 376 may receive the RSS feeds using any of a variety of messaging protocols, including, but not limited to HTML, XML, email, IM, or the like. In one embodiment, the messaging application may receive messages through an MMS, instant messaging, SMS, IRC, mIRC, Jabber, EMS, text messaging, Smart Messaging, OTA messaging, and the like. Messaging application 376 may use a browser application to format and display RSS feeds. In one embodiment, the browser application is enabled to employ at least HTML, Dynamic HTML, HDML, WML, WMLScript, JavaScript, xHTML, CHTML, Voice XML, and the like. In another embodiment, the messaging application 376 may use a proprietary graphical user interface. In one embodiment, the messaging application is adapted to receive at least one message and display the message(s) in real-time. Messaging application 376 may further receive an RSS alert indicating that RCS content is available for access by client device 300. In one embodiment messaging application 376 may, in part, establish a network connection with a delivery server, such as RSS delivery server 124 of FIG. 1 to access the content. In another embodiment, the messaging application periodically requests RSS delivery server 124 for content that is available through a network connection, receives an alert indicating that the RCS content is available, or the RCS content itself, and displays the RSS alert and/or RCS content possibly in real-time by way of a browser application, a proprietary graphical user interface, or other interface.

Illustrative Screen Layouts

FIG. 4 shows one embodiment of an example screen layout of a search result for use in subscribing to an RSS alert. Display 400 may include many more components than those shown. The components shown, however, are sufficient to disclose an illustrative embodiment for practicing the invention. In one embodiment, a process such as described below in conjunction with FIG. 7 may employ display 400, in part, for subscribing to an RSS alert based on a search.

As shown in the figure, display 400 includes search entry component 402, search results 414-416, and selection components 404-407. Search results 414-416 are associated with selection components 404-406, respectively. That is, selection component 404 may be used to select an RSS feed associated with search results 414 for subscription. Similarly, selection component 405 enables selection of an RSS feed for search results 415, and selection component 406 enables selection of an RSS feed for search results 416. Moreover, selection component 407 may enable a user to subscribe to the search query results as an RSS feed. By subscribing to the search query results as an RSS feed, the user may be alerted to changes to the results of the search query over time.

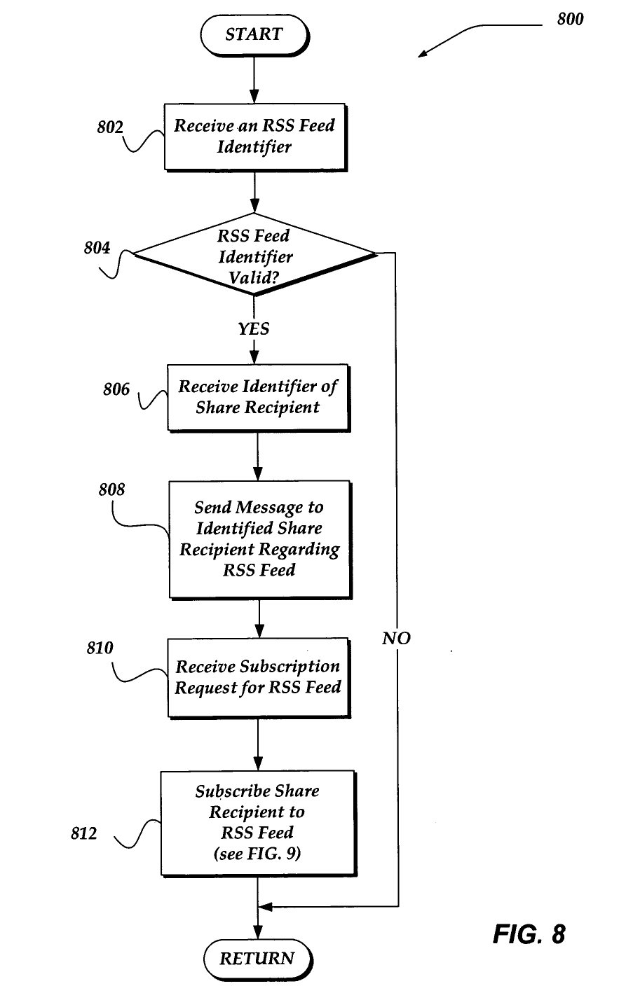

Search entry component 402 is configured to enable a user to enter a variety of search terms, Boolean expressions, search statements, or the like, usable to perform a search over a network for content associated with an RSS feed. Selection components 404-407 are configured, when selected, to send an RSS alert subscription request to a subscription manager, such as subscription manager 257 of FIG. 2. Selection components 404-407 may include any of a variety of mechanisms for sending the request, including an icon, an HTTP hyperlink, a script, a menu, or the like. In one embodiment, the request may include user profile information, information associated with the RSS feed selected, or the like. In one embodiment, in response to the subscription request, the subscription manager may send to the subscriber a subscription interface such as shown in FIG. 6. Although not shown, in one embodiment selection components 404-407 may be configured to send a message to another user that indicates that the selected RSS feed is available. In one embodiment, the request may include user profile information, information associated with the RSS feed shared, or the like. FIG. 5 shows one embodiment of an example screen layout for use in sharing an RSS alert. Display 500 may include many more components than those shown. The components shown, however, are sufficient to disclose an illustrative embodiment for practicing the invention. As shown in the figure, display 500 includes RSS feed 502, RSS alerts 508, RSS feed content 510, and a share component 520. Share component 520 may include any of a variety of mechanisms that when selected enables sharing of an RSS feed, including an icon, hyperlink, menu, or the like. In one embodiment, when share component 520 is selected, a message may be sent to another user that indicates that RSS feed 502 is available. In one embodiment, the request may include user profile information, information associated with the RSS feed shared, or the like. One embodiment of a process that may employ display 500 for sharing an RSS feed is described below in conjunction with FIG. 8.

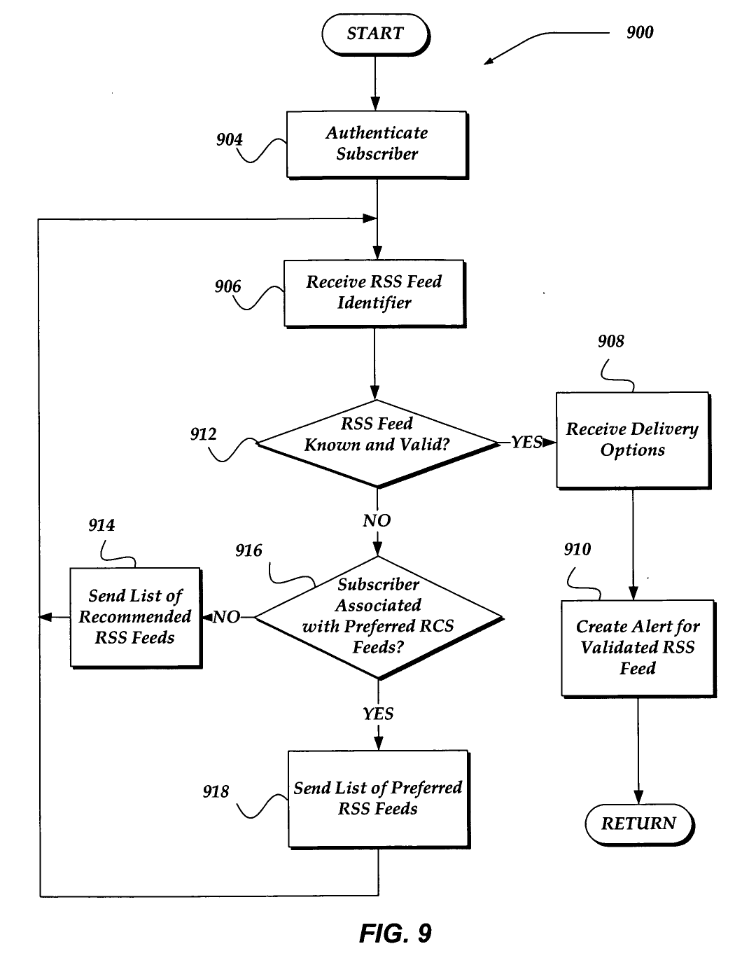

FIG. 6 shows one embodiment of an example screen layout for use in managing a subscription to an RSS alert. Display 600 may include many more components than those shown. The components shown, however, are sufficient to disclose an illustrative embodiment for practicing the invention. In one embodiment, display 600 may be employed by a process such as described below in conjunction with FIG. 9.

As shown in the figure, display 600 includes input component 604 for receiving an RSS feed identifier, selection component 606, delivery options 608-609, and submission component 610. Although not shown, in one embodiment, display 600 may also include a search component for use in entering and performing a search for an RSS feed. Although not shown, in one embodiment, display 600 may also include a share component for use in sending a message to another user that indicates a RSS feed associated with the received RCS identifier is available. The components shown illustrate one way of managing a subscription of an RSS feed, and is not intended to be limiting. Thus, other mechanisms, menus, links, windows, fill in the blanks, or the like, may be employed without departing from the scope or spirit of the invention. Moreover, the components shown may employ a variety of mechanisms, including web-based frames, a single HyperText Transport Protocol (HTTP) web page, java scripts, XML, applets, or the like. In one embodiment, the invention enables a user to readily view various components in an overlay manner; however, the invention is not so limited, and the components may also be displayed in another arrangement. For example, in one embodiment, at least some of the components may be displayed in a first display, and other components may be displayed in a subsequent display.

As shown however, selection component 606 displays a list of preferred RSS feeds associated with a subscriber. The list of preferred RSS feeds may be stored and associated with a subscriber in a data source, such as subscriber store 110 of FIG. 1, or the like. In another embodiment, a subscriber may not be associated with a list of preferred RSS feeds. In that instance, selection component 606 may provide a list of recommended RSS feeds. In one embodiment, the recommended RSS feeds may include RSS feeds that may be selected based on a behavior of the subscriber, a list of popular RSS feeds, a shared RSS feed, RSS feeds that may have paid for a position in the list, or the like.

In one embodiment, an RSS feed identifier may be provided through another mechanism, such as a share mechanism, or the like. Thus, in one embodiment, display 600 may display the provided RSS feed identifier label rather than, or in addition to, input component 604 and/or selection component 606.

Delivery options 608 may include a mechanism for selection of a frequency of delivery for the RSS feed alert. In addition, delivery options 609 may provide a mechanism for selection of a mode(s) of delivery for the RSS feed alert. In one embodiment delivery options 609 may display various subscriber profile information such as an email address, an instant messenger identifier, a telephone-number, or the like.

Delivery options 608-609 may also include, although not illustrated, a target language of delivery, transcoding options to transform the content from one format into another, delivery time restriction that among other things may indicate that the RSS alert is not to be delivered before, after, or during a certain time, a list of other user-ids to which a particular alert may also be automatically routed, or the like. Delivery options 608-609 and other information obtainable from an interaction with display 600 may be provided to a data store, such as subscriber store 110 of FIG. 1. In one embodiment, delivery options 608-609, and other information may be provided to the data store when submission component 610 is selected. In another embodiment, at least a portion of the information and/or delivery options 608-609 may be provided to the data store during interaction with display 600.

Generalized Operation The operation of certain aspects of the invention will now be described with respect to FIGS. 7-9. FIG. 7 illustrates a logical flow diagram generally showing an embodiment of a process for managing a subscription request based on a search query. Process 700 of FIG. 7 may be implemented, for example, within subscription server 106 of FIG. 1.

Process 700 begins, after a start block, at block 704, where a search component receives a search query. The search query may be in the form of a list of search terms; a Boolean query comprising of one or more logical operators, such as AND, OR, NOT, or the like, along with one or more search terms; a structured query language (SQL) statement; a URL; or the like. The search query may be provided by a search engine, an output from another process, an output of an RSS configuration tool, or the like. In one embodiment, the search query is entered by a subscriber. In another embodiment, the search query may be entered using display 600 of FIG. 6. In another embodiment, the search query may be received from an external component, such as a third party search tool, a stored search query, or the like. In yet another embodiment, the search query may be retrieved from a data store, such as subscriber store 110 of FIG. 1, or the like.

Processing next continues to block 706, where a search may be performed based on the received search query. In one embodiment, the search is performed using a crawler, a search engine, a full-text indexing component of a database, a relational database component, an aggregation search service, or the like. The search may then provide results from the search query. The search query results may be in the form of a list of content source identifiers, or the like. In one embodiment, the content source identifiers are URLs.

Processing next continues to block 708, where the results of the search are validated to determine whether at least one RSS feed is associated with the each resulting content source identifier. In one embodiment, the search component may compare the search query results against RSS feed identifiers stored in a data store, such as feed store 112 of FIG. 1. In another embodiment, the search component may parse the result for patterns that identify the result as an RSS feed, or the like. Results that are determined to be unassociated with an RSS feed may be discarded. In one embodiment, where the search query results may be selectable as an RSS feed, validation may be performed to determine whether there search results include content.

Processing further continues to block 710, where the validated RSS feed(s) may be sent to a user. In one embodiment, the validated RSS feed(s) may be sent to a subscriber for use with a display such as display 400 of FIG. 4 described above.

Processing next continues to block 714, where a subscription request may be received for a validated RSS feed. In one embodiment, a user may employ display 400 of FIG. 4 to send the subscription request. The subscription request may be sent via any messaging mechanism, including IM, SMS, MMS, IRC, EMS, audio messages, HTTP/HTML, email, or the like. In one embodiment, the subscription request includes an RSS feed identifier.

Processing then continues to block 716, where a subscription manager subscribes the user to the requested RSS feed. Block 716 is described in more detail below in conjunction with FIG. 9. In one embodiment, the subscriber may also subscribe to an RSS alert that indicates a change between results of the search query of block 704 performed at different times. Processing then may return to a calling process to perform other actions.

FIG. 8 illustrates a logical flow diagram generally showing one embodiment of a process for sharing a subscription to an RSS alert. Process 800 of FIG. 8 may be implemented for example, within subscription server 106 of FIG. 1. In one embodiment, process 800 may employ a display such as display 500 of FIG. 5.

Process 800 begins, after a start block, at block 802, where an RSS feed identifier is received. The RSS feed identifier may be received from a variety of sources, including based on use of display 400 of FIG. 4, a return value of an invocation of an API, a data store such as subscriber store 110, or the like.

Next processing continues to decision block 804, where a determination is made whether the RSS feed identifier is valid. To check for validity, a comparison may be made of the received RSS feed identifier against information stored in a data store, such as feed store 112 of FIG. 1. In another embodiment, the RSS feed identifier may be compared to a content of a database. In still another embodiment, a ping, or other network test may be performed using the RSS feed identifier. In any event, if a valid RSS feed identifier has been received, then processing continues to block 806; otherwise, processing may exit to a calling process to perform other actions, including requesting another RSS feed identifier, providing an error message, or the like.

At block 806, an identifier associated with a share recipient (e.g., a user with which the RSS feed is to be shared) is received. Next, processing continues to block 808, where a message is sent to the identified share recipient regarding the RSS feed associated with the validated RSS feed identifier. The message may be sent via any messaging mechanism, including IM, SMS, MMS, IRC, EMS, audio messages, HTTP/HTML, email, or the like. In one embodiment, the message may include a subscription mechanism that may be used to subscribe the share recipient to the validated RSS feed. In one embodiment, the subscription mechanism may include a URL to a subscription display, such as display 600 of FIG. 6.

Processing flows to block 810, where, a subscription request may be received based on the RSS feed. The subscription request may be received via any messaging mechanism, including those described above. The subscription request may additionally be in the form of an invocation of an API implemented by the subscription manager. In one embodiment, the subscription request includes an RSS feed identifier.

Processing continues to block 812, which is described in more detail below in conjunction with FIG. 9. Briefly, however, at block 812, a request for subscription to an RSS feed is managed. Upon completion of block 812, processing then may return to the calling process to perform other actions.

FIG. 9 illustrates a logical flow diagram generally showing one embodiment of a process for providing a subscription to an RSS alert over a network. As such, at least a portion of process 900 of FIG. 9 may be implemented, for example, within subscription server 106 of FIG. 1.

Process 900 begins after a start block, at block 904, where a subscriber may be authenticated. In one embodiment, the subscriber may be authenticated based on information received from the subscriber, and comparing such information to subscriber information stored in a data source, such as subscriber store 110 of FIG. 1, or the like. In another embodiment, a user-id and/or password may be received to authenticate the subscriber. In another embodiment, information may be received in a browser's cookie, a digital certificate, a form input, or the like. If the subscriber is authenticated, processing proceeds to block 906. Although not shown, in one embodiment, if the subscriber is not authenticated, process 900 may exit, may provide the subscriber another attempt to become authenticated, or perform a variety of other actions.

At block 906, a RSS feed identifier is received. The RSS feed identifier may be received via any messaging mechanism. In one embodiment, the RSS feed identifier is received via an HTTP POST or HTTP GET message sent by display 600 of FIG. 6. In another embodiment, the RSS feed identifier may be received in a message in an invocation of an API or the return value of an invocation of an API. Where the RSS feed is the search query results, an RSS feed identifier may be associated with the search query.

Process 900 continues next to decision block 912, where a determination is made whether the received RSS feed identifier is known, and is valid. That is, is the RSS feed identifier associated with an RSS feed source that is currently active. The RSS feed identifier may be invalid for a variety of reasons, including, but not limited to the RCS having terminated the RSS feed, the RSS feed identifier was incorrectly entered, or the like. Where the RSS feed is the search query results, invalidity may be because the search query results is an empty set.

Validation may be determined using a variety of mechanisms, including by sending the RSS feed identifier to a third party for validation, searching a network based on the received RSS feed identifier, performing a network ping, or the like. In one embodiment, the RSS feed identifier may be validated by searching a data source of pre-validated RSS feeds.

If at decision block 912, an RSS feed identifier is unknown, or the RSS feed identifier is determined to be otherwise invalid, processing flows to decision block 916; otherwise, processing branches to block 908.

At block 908, a delivery option for the validated RSS feed is received. The delivery option may include any of a variety of delivery information, including a frequency of delivery, a mode of delivery, a target language for the RSS alert, a transcoding option to may enable the RCS content to be transformed from one format into another, a cut-off time to inhibit delivery before, during or after a certain time, a list of other user-ids to which a particular RSS alert may also be automatically routed, or the like.

Processing continues to block 910, where an RSS alert for the validated RSS feed is created. In one embodiment, the RSS alert, including the associated delivery option, may be stored in the subscriber profile store, such as subscriber store 110, for use by match servers 122-123, and/or RSS delivery server 124 of FIG. 1. Processing then may return to a calling process to perform other actions.

At decision block 916, because the RSS feed identifier is unknown and/or invalid, a determination is made whether a list of preferred RSS feeds is associated with the subscriber. Such a preferred list may be associated with the subscriber where the subscriber has previously identified an RSS feed. In one embodiment, the preferred list may be stored in any data source, such as template store 136, feed store 112, subscription server 106 of FIG. 1, or the like. In any event, if a list of preferred RSS feeds is associated with the subscriber, processing continues to block 918, where the list of preferred RSS feeds is provided to the subscriber. Processing loops back to block 906, where the subscriber may then select an RSS feed from the list.

However, if at decision block 916 it is determined that a list of preferred RSS feeds is not associated with the subscriber, processing branches to block 914. At block 914, a list of recommended RSS feeds are provided to the subscriber for possible selection. The list of recommended RSS feeds may include RSS feeds that are determined based on a subscriber's behavior, information from the subscriber profile, RSS feeds that are rated by one or more subscribers higher than other RSS feeds, RSS feeds based on several subscriber profiles, or the like. In any event, processing loops back to block 906, where the subscriber may then select an RSS feed from the list.

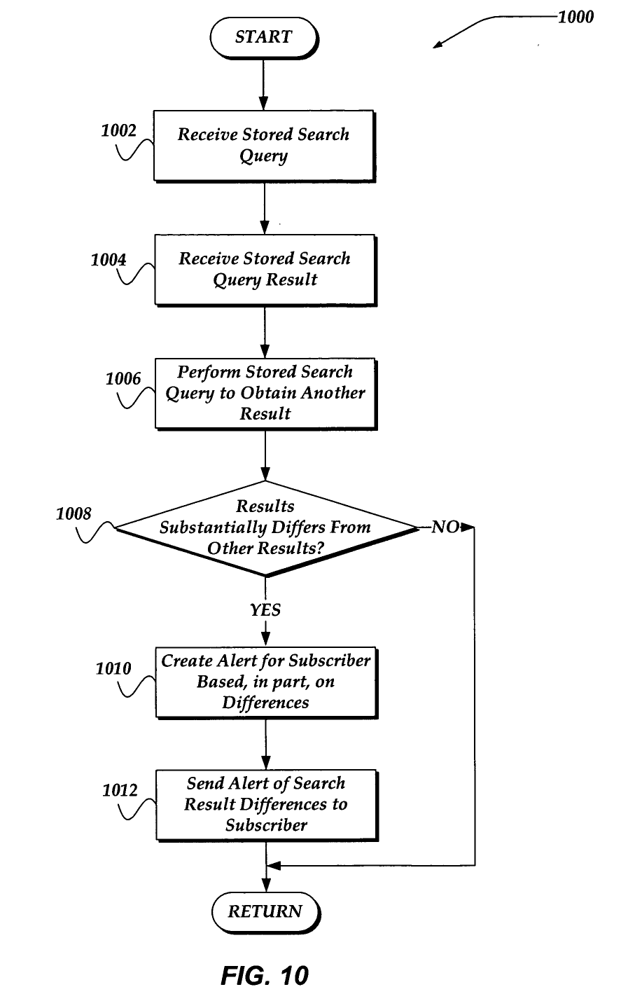

FIG. 10 illustrates a logical flow diagram generally showing one embodiment of a process for providing an RSS alert based on a detected change to a search query result that is configured to operate as an RSS feed. Process 1000 of FIG. 10 may be employed to automatically detect for changes in the results of a search query. Detected changes may then be provided to the subscriber through an RSS alert. In one embodiment, process 1000 may be implemented, at least in part, within collection server 108 of FIG. 1. Process 1000 may be entered based on a variety of criteria. For example, process 1000 may be automatically performed periodically, based on information received from an RCS, a third party, another subscriber, or the like. In one embodiment, the subscriber may subscribe to RSS alerts specifically for detected differences in a provided search query.

Process 1000 begins, after a start block, at block 1002, where a stored search query is received. In one embodiment, the stored search query is stored based on a subscriber. Processing the proceeds to block 1004 where a stored search result for the received stored search query is received. In one embodiment, the result is in a form of a hash, a compressed file, or the like, that is determined based on at least some of the search results.

Processing continues to block 1006 where the stored search query is performed to obtain another search query results. Processing then flows to decision block 1008, where a comparison is performed between the received search query results from block 1004 and the search query results obtained at block 1006. If a substantial difference is detected, processing flows to block 1010; otherwise, processing may return to a calling process to perform other actions. In one embodiment, a substantial difference may be based on content differences, other than title changes, date changes, or the like. For example, a substantial difference may include a change in the identified RSS feeds, or the like.

At block 1010, if a difference in the results is detected, an RSS alert may be created for the subscriber based, in part, on the differences. Processing continues next to block 1012, where the RSS alert may be send to the subscriber. Process 1000 then may return to the calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of providing content as an RSS feed over a network, comprising:
receiving a search query for content over the network;
providing a result based on the search query, the result being subscribed to as the RSS feed;
repeating the search query to obtain another result associated with the content; and
if the result and the other result are substantially different, providing an RSS alert based, in part, on the difference.

2. The method of claim 1, further comprising:
receiving an indication that the RSS feed is to be shared; and
sending a message that enables another subscription to the RSS feed.

3. The method of claim 1, wherein the received search query includes at least one of a structured query language (SQL) instruction, a Boolean expression, or a search query selected from a list of search queries.

4. The method of claim 1, wherein the result includes at least one item that is separately selectable as another RSS feed.

5. The method of claim 1, further comprising:
If the result includes an empty set, providing at least one of a preferred RSS feed, a recommended RSS feed, or a list of search queries.

6. A modulated data signal configured to include program instructions for performing the method of claim 1.

7. A system for use in providing content as an RSS feed over a network, comprising:
a subscription component that is operative to perform actions, comprising:
receiving a search query for content;
performing the search query to determine a result; and
enabling a client to subscribe to the search query result as the RSS feed; and
a collector that is operative to perform action, comprising:
repeating the search query to determine another result; and
if the result and the other result substantially differ, enabling an RSS alert to be provided to the client.

8. The system of claim 7, wherein enabling the client to subscribe to the RSS feed further comprises providing at least one of an icon, an HTTP hyperlink, a script, or a menu.

9. The system of claim 7, wherein receiving the search query further comprises receiving a stored search query, receiving the search query from the client, receiving the search query from a third party, receiving a Boolean expression, or receiving a structured query language (SQL) instruction.

10. The system of claim 7, wherein the client is a mobile device.

11. The system of claim 7, wherein the subscription component is operative to perform actions, further comprising:
enabling the client to subscribe to at least one item within the search query result as another RSS feed.

12. A server that is configured for use in providing content as an RSS feed over a network, comprising:
a transceiver for receiving and for sending information over the network; and
program code that is operative to perform actions comprising:
receiving a search query for use in searching for content over the network;
performing the search query to obtain a result, the result being selectable as an RSS feed;
repeating the search query to determine another result; and
if the result and the other result substantially differs, sending an RSS alert indicating that the result of the search query has changed.

13. The server of claim 12, wherein obtaining the result further comprises obtaining the result based, in part, on a Boolean expression.

14. The server of claim 12, wherein the result further comprises at least one item that is selectable as another RSS feed.

15. The server of claim 12, the actions further comprising:
if the RSS feed includes an empty set, providing at list one of a preferred RSS feed, a list of search queries, or an recommended RSS feed.

16. The server of claim 12, wherein receiving the search query further comprises receiving the search query as at least one of an structured query language (SQL) instruction, as a Boolean expression, as a search from a third party, or selected from a list of search queries.

17. A client that is operative for providing content as an RSS feed over a network, comprising:
a memory component for storing data; and
a processing component for executing data that enables actions, including:
entering a query for use in searching for content over the network;
receiving a result associated with the query;
subscribing to the result as the RSS feed; and
receiving an RSS alert indicating a difference between the result of the query and another result of an automatic search based on the query.

18. The client of claim 17, wherein subscribing to the result further comprises selecting at least one of a frequency of delivery, a target language, a delivery mechanism, or a delivery time restriction.

19. The client of claim 17, wherein the result associated with the query further comprises at least one item that is selectable as another RSS feed.

20. The client of claim 17, wherein receiving the RSS alert receiving a share mechanism for use in sharing the RSS feed with another client.

21. The client of claim 17, wherein the search query further comprises at least one of a structured query language (SQL) instruction, another search query from a third party, or a Boolean expression.

22. The client of claim 17, wherein subscribing to the result further comprises identifying the query to be automatically re-performed to detect the difference between the result and another result.

23. A processor readable medium that includes data, wherein the execution of the data provides for providing content as an RSS feed over a network, comprising:
determining a result of a search query for content;
subscribing to the result of the search query as an RSS feed; and
receiving an RSS alert indicating a detection of a difference between the result of the search query and another result of an automatic performing of the search query.
